(19) United States
(12) Patent Application Publication
(10) Pub. No.: US 2016/0026961 A1
(43) Pub. Date: Jan. 28, 2016

(54) SOCIAL SELLING INDEX SCORES FOR MEASURING SOCIAL SELLING PRACTICES

(71) Applicant: Linkedln Corporation, Mountain View, CA (US)

(72) Inventors: Chen Chang, San Jose, CA (US); Daniel I. Lurie, San Francisco, CA (US); Michael J. Miller, San Francisco, CA (US); Wenjing Zhang, Menlo Park, CA (US); Nicholas Lewis VanWagner, San Francisco, CA (US)

(21) Appl. No.: 14/340,372

(22) Filed: Jul. 24, 2014

(51) Int. Cl. G06Q 10/06; G06Q 30/02; G06Q 50/00; G06F 17/30

(52) U.S. Cl. CPC G06Q 10/06398; G06F 17/30876; G06Q 30/02; G06Q 50/01

(57) ABSTRACT

The disclosed embodiments provide a system that processes data. During operation, the system obtains a set of data associated with social selling practices for a sales entity on a social network. Next, the system calculates, on a processor, a set of metrics from the data, wherein the metrics are associated with creating a professional brand, finding prospects, engaging with insights, and building relationships. The system then aggregates the metrics into a social selling index (SSI) score for the sales entity. Finally, the system provides the SSI score for use in managing the social selling practices of the sales entity.

### BACKGROUND

1. Field

The disclosed embodiments relate to measurements of social selling practices. More specifically, the disclosed embodiments relate to techniques for calculating social selling index scores from metrics associated with social selling practices.

2. Related Art

Social networks may include nodes representing individuals and/or organizations, along with links between pairs of nodes that represent different types and/or levels of social familiarity between the nodes. For example, two nodes in a social network may be connected as friends, acquaintances, family members, and/or professional contacts. Social networks may further be tracked and/or maintained on web-based social networking services, such as online professional networks that allow the individuals and/or organizations to establish and maintain professional connections, list work and community experience, endorse and/or recommend one another, run advertising and marketing campaigns, promote products and/or services, and/or search and apply for jobs.

In turn, social networks and/or online professional networks may facilitate sales activities and operations by the individuals and/or organizations. For example, sales professionals may use an online professional network to locate prospects, maintain a professional image, establish and maintain relationships, and/or engage with other individuals and organizations. Moreover, higher-performing sales professionals may leverage social networking features to conduct social selling practices more successfully than lower-performing sales professionals may. For example, the higher-performing sales professionals may be more successful than the lower-performing sales professionals at targeting the right prospects, building relationships, and/or establishing a professional presence and dynamic through the online professional network.

Consequently, a sales professional's sales performance may be improved by using a social network and/or online professional network to effectively carry out social selling practices.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

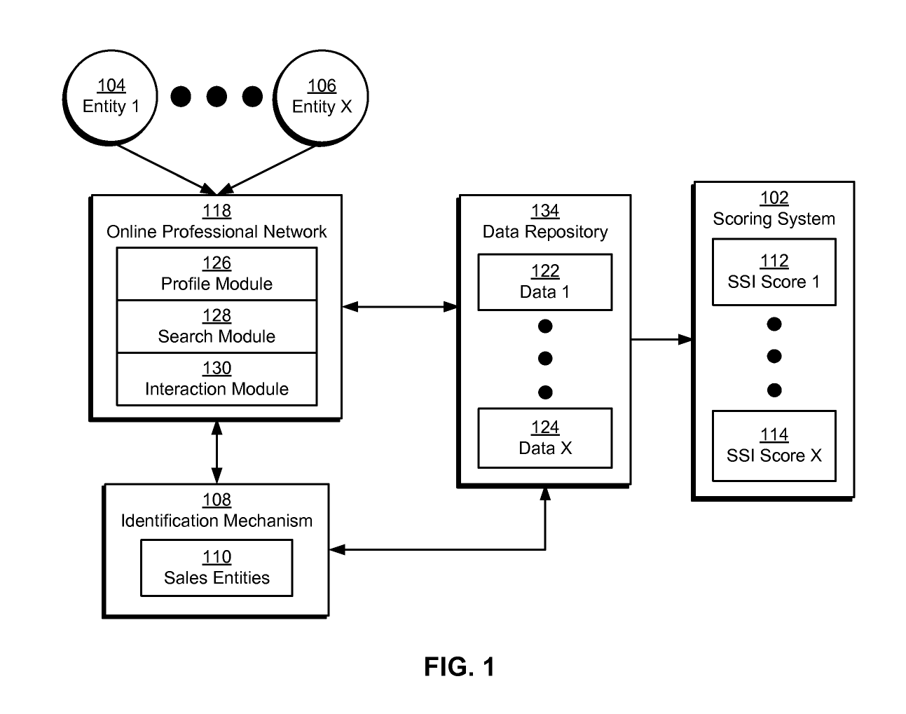

The disclosed embodiments provide a method and system for processing data. More specifically, the disclosed embodiments provide a method and system for calculating social selling index (SSI) scores as measurements of social selling practices on a social network, from metrics associated with the social selling practices. As shown in FIG. 1, the social network may be an online professional network 118 that allows a set of entities (e.g., entity 1 104, entity x 106) to interact with one another in a professional and/or business context.

For example, the entities may include users that use online professional network 118 to establish and maintain professional connections, list work and community experience, endorse and/or recommend one another, and/or search and apply for jobs. The entities may also include companies, employers, and/or recruiters that use online professional network 118 to list jobs, search for potential candidates, and/or provide business-related updates to users.

The entities may use a profile module 126 in online professional network 118 to create and edit profiles containing profile pictures, along with information related to the entities' professional and/or industry backgrounds, experiences, summaries, projects, and/or skills Profile module 126 may also allow the entities to view the profiles of other entities in online professional network 118.

Next, the entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on online professional network 118 to search for profiles, jobs, and/or information by categories such as first name, last name, title, company, school, location, interests, relationship, industry, groups, salary, and/or experience level.

The entities may also use an interaction module 130 to interact with other entities on online professional network 118. For example, interaction module 130 may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or newsfeed that provides the latest postings, articles, and/or updates from the entities' connections and/or groups to the entities. Similarly, online professional network 118 may include mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in online professional network 118 may be tracked and stored in a database, data warehouse, cloud storage, and/or other data-storage mechanism providing data repository 134.

The entities may further include a set of sales entities 110 that use online professional network 118 to conduct or manage sales-related activities such as establishing relationships with customers, finding prospects, maintaining a market presence, and/or sharing information with other entities in online professional network 118. In other words, sales entities 110 may be sales professionals and/or sales organizations who use online professional network 118 and/or another social network to develop social selling practices that improve the sales performance of sales entities 110.

In one or more embodiments, the system of FIG. 1 includes functionality to facilitate effective social selling practices by sales entities 110 on online professional network 118. As shown in FIG. 1, sales entities 110 in online professional network 118 may be identified by an identification mechanism 108 using data from data repository 134 and/or online professional network 118. For example, identification mechanism 108 may identify sales entities 110 by matching profile data for the entities' headlines and current positions to sales-related keywords. Identification mechanism 108 may also use other data, such as membership in sales-related groups, listing of sales-related industries, and/or endorsements of sales-related skills, to determine if an entity in online professional network 118 is a sales entity.

After sales entities 110 are identified, a scoring system 102 may calculate an SSI score (e.g., SSI score 1 112, SSI score x 114) for each sales entity identified by identification mechanism 108. Alternatively, scoring system 102 may calculate SSI scores for all entities in online professional network 118. As with other data related to the entities and/or sales entities 110, the SSI scores may be stored in data repository 134 and/or another repository for subsequent retrieval and use.

As described in further detail below, an entity's SSI score may be calculated from a set of metrics associated with social selling practices for the entity. The metrics may be associated with a number of social selling categories, including creating a professional brand, finding prospects, engaging with insights, and building relationships. The metrics may be aggregated into the SSI score, and the SSI score may be provided for use in managing the social selling practices of the entity.

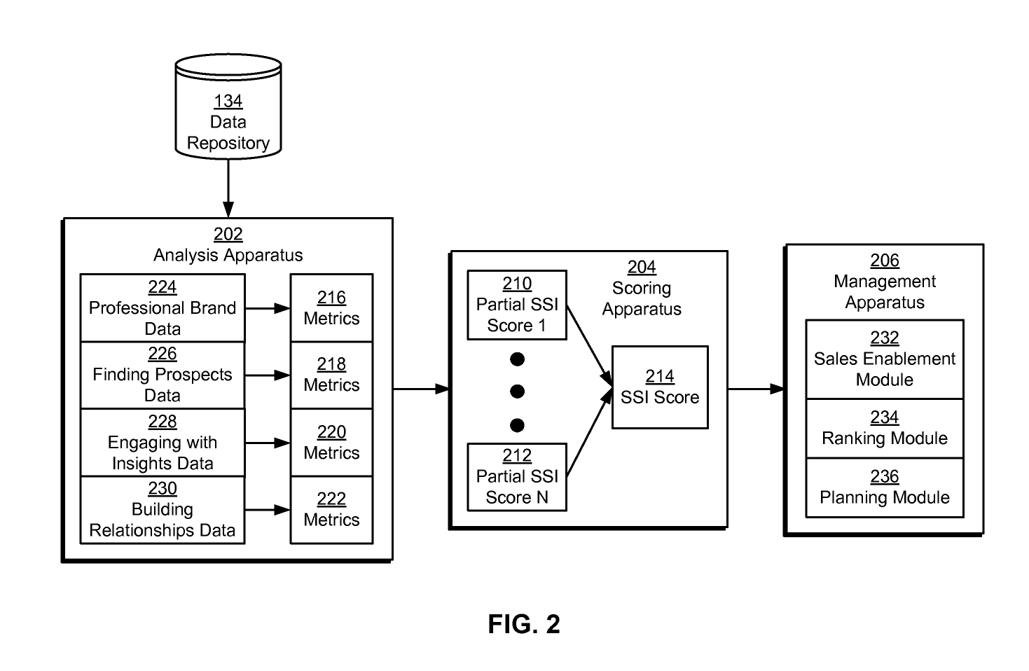

FIG. 2 shows a system for processing data in accordance with the disclosed embodiments. More specifically, FIG. 2 shows a system for calculating and using an SSI score 214 for a sales entity, such as scoring system 102 of FIG. 1. The sales entity may be identified by matching data associated with the sales entity to sales-related keywords, industries, skills, and/or groups. As shown in FIG. 2, the system includes an analysis apparatus 202, a scoring apparatus 204, and a management apparatus 206. Each of these components is described in further detail below.

Analysis apparatus 202 may calculate a set of metrics 216-222 from data associated with the sales entity in data repository 134. As mentioned above, metrics 216-222 may be associated with categories such as creating a professional brand, finding prospects, engaging with insights, and building relationships. Data used to calculate metrics 216-222 may include professional brand data 224 associated with the sales entity's professional brand, finding prospects data 226 associated with the sales entity's ability to find prospects, engaging with insights data 228 associated with the sales entity's ability to engage with insights, and building relationships data 230 associated with the sales entity's ability to build relationships.

More specifically, professional brand data 224 may include data associated with the sales entity's profile on a social network and/or online professional network (e.g., online professional network 118 of FIG. 1). In turn, metrics 216 calculated from professional brand data 224 may include profile metrics such as a profile completeness (e.g., number or percentage of fields populated in the sales entity's profile), a profile length (e.g., number of words in the sales entity's profile), and/or a rich content metric (e.g., amount of multimedia and/or other rich content in the sales entity's profile). Metrics 216 may also be associated with endorsements of the sales entity on the social and/or online professional network. For example, metrics 216 may include an endorsement metric that represents the number of inbound endorsements of sales-related skills of the sales entity by other entities.

Finding prospects data 226 may include data related to people searches and/or profile views performed by the sales entity. As a result, metrics 218 calculated from finding prospects data 226 may include a people search metric that represents the number and/or frequency of people searches performed by the sales entity. Metrics 218 may also include a separate people search metric that measures the use of advanced people searches by the sales entity. Moreover, metrics 218 may include one or more profile view metrics that represent the number and/or frequency of the sales entity's overall profile views, prospecting profile views (e.g., profile views of entities that are at least three degrees of separation from the sales entity), and inbound profile views (e.g., profile views of the sales entity's profile by other entities).

Engaging with insights data 228 may include data related to the sales entity's interaction with other entities in the social network and/or online professional network. For example, engaging with insights data 228 may include data representing shares of articles or posts; inbound and outbound engagements such as likes, comments, and re-shares; messages sent; connection requests; groups joined; and companies followed. In turn, metrics 220 calculated from engaging with insights data 228 may include a share metric representing the amount or frequency of sharing performed by the sales entity, as well as one or more engagement metrics measuring the amount of outbound and/or inbound engagements (e.g., likes, comments, re-shares) associated with the sales entity. Metrics 220 may further include a messaging metric representing the amount and/or frequency of messaging performed by the sales entity, a group participation metric representing the sales entity's membership or participation in professional groups, and a following metric indicating the number of other entities (e.g., leaders, companies, etc.) followed by the sales entity.

Building relationships data 230 may be data representing the sales entity's connections with other entities in the social and/or online professional network. As a result, metrics 222 calculated from building relationships data 230 may include a number of connections, a number of senior connections (e.g., connections with entities in senior positions), and/or a number of internal connections (e.g., connections to entities in the same organization).

In one or more embodiments, metrics 216-222 are calculated by applying a set of gradients to different subsets of professional brand data 224, finding prospects data 226, engaging with insights data 228, and/or building relationships data 230 to obtain a score associated with each subset of data. As a result, each metric may be calculated using a different formula, set of thresholds, and/or gradient scale.

For example, a profile completeness metric calculated from professional brand data 224 may be calculated by aggregating a set of scores representing completion of different parts of the sales entity's profile, such as listed job positions, number of connections, profile picture, education, skills, industry, location, description of current position, and recent updates to the current position. Each score may be calculated using one or more thresholds: the score for listed job positions may increase with the number of listed job positions up to a certain number, while the score for skills may be positive if the number of listed skills exceeds a threshold and zero if the number of listed skills is below the threshold. The scores may then be summed to obtain an overall profile completeness score for the sales entity.

Similarly, an endorsement metric may be calculated from professional brand data 224 by aggregating the number of inbound endorsements for the entity and applying a different formula to the number based on one or more thresholds. As a result, ranges for different numbers of endorsements (e.g., 1-20, 21-50, 51-100, etc.) may be multiplied by different weights (e.g., 0.5, 1, 0.3, etc.) so that endorsements in different ranges contribute different amounts to the overall endorsement metric for the entity. For example, each of the first 20 endorsements may contribute 0.5 to the endorsement metric, while each of the next 30 endorsements (e.g., the 21^{st} to the 50^{th} endorsements) may contribute 0.6 to the endorsement metric.

Professional brand data 224 may also be used to calculate a profile length metric, a rich content metric, and/or an endorsement metric. The profile length metric may be obtained as the number of words in the entity's profile, and the rich content metric may be obtained as the number of rich content items (e.g., multimedia items) in the entity's profile.

Finding prospects data 226 may be used to calculate a people search metric and/or a profile view metric. The people search metric may be associated with a regular people search or an advanced people search. For example, a regular people search metric may be calculated by applying a set of weights (e.g., 2, 1, 0.6, etc.) to ranges for numbers of regular people searches (e.g., 1-10, 11-50, 51-100, etc.) performed over a pre-specified period (e.g., the last month) by the entity. A separate advanced people search metric may be calculated by applying a different set of weights (e.g., 2, 1.33, 0.67, etc.) to different ranges for numbers of advanced people searches (e.g., 1-20, 21-50, 51-80, etc.) performed over the same period.

The profile view metric may represent profile views, prospecting profile views, and/or inbound profile views for the entity. For example, an overall profile view metric may be calculated by multiplying ranges for numbers of overall profile views by the entity (e.g., 1-10, 11-50, 51-100) over a pre-specified period by weights (e.g., 2, 1, 0.6, etc.) for the ranges. A prospecting profile view metric may be calculated using a second set of ranges (e.g., 1-5, 6-20, 21-42, etc.) for numbers of prospecting profile views (e.g., profile views of entities that are at least three degrees of separation from the sales entity) over the same period and a second set of weights (e.g., 4, 2.33, 2, etc.) for the second set of ranges. An inbound profile view metric may be calculated using a third set of ranges (e.g., 1-10, 11-50, 51-90, etc.) for numbers of inbound profile views (e.g., profile views of the sales entity's profile by other entities) over the same period and a third set of weights (e.g., 2, 1.25, 0.75, etc.) for the third set of ranges.

Engaging with insights data 228 may be used to calculate a share metric, an engagement metric, a messaging metric, a group participation metric, and/or a following metric. Each metric may be calculated as a score of up to 100 based on the entity's interaction with other entities in the social and/or online professional network. For example, the share metric may be calculated by mapping the entity's number of shares (e.g., 1, 2, 3, etc.) over a pre-specified period to a pre-defined score (e.g., 50, 75, 100, etc.). The engagement metric may include an engagements-received score of up to 100 that is produced from the number of engagements (e.g., likes, comments, re-shares, etc.) received by the entity from other entities, as well as an engagements-given score of up to 100 that is produced from the number of engagements given by the entity. The messaging metric may be calculated by mapping the number of messages sent by the entity (e.g., 1, 2, 3, etc.) over a pre-specified period (e.g., a number of months or years) to a pre-defined score (e.g., 50, 75, 90, 100). The group participation metric may be calculated as a score of up to 100 that is produced from the number of groups followed by the entity, with a maximum score achieved with 40 to 50 groups followed. The following metric may be calculated as a score of up to 100 that is produced from the number of companies followed by the entity, with a maximum score achieved with 40 to 50 companies followed.

Building relationships data 230 may be used to calculate metrics 222 associated with the entity's number of connections, number of senior connections, and/or number of internal connections. Each metric may be a score of up to 100 that is calculated from the corresponding number of connections. As with other metrics 216-222 calculated by analysis apparatus, the scores may be calculated from different ranges of numbers and/or weights. For example, the entity may have a maximum score for number of connections if the entity has more than several hundred connections, a maximum score for number of senior connections if the entity has more than 100 or 200 senior-level (e.g., Vice President and above) connections, and a maximum score for number of internal connections (e.g., connections from the same company as the entity) if the entity has more than 50 or 60 internal connections.

In turn, the formula and/or thresholds may be adjusted to change the gradient scale used to calculate each metric. Continuing with the above example, the thresholds associated with the profile completeness score may be set higher to weight the gradient scale toward the upper end of profile completeness. The profile completeness score may further be adjusted using an additional set of weights and/or thresholds to penalize less complete profiles. For example, the sales entity may achieve a maximum profile completeness score of 70 out of 100 for a profile that is up to 90% complete, with the remaining 30 points for the profile completeness score awarded for 90-100% profile completeness.

After metrics 216-222 are calculated by analysis apparatus 202, scoring apparatus 204 may aggregate metrics 216-222 into SSI score 214 for the sales entity. First, scoring apparatus 204 may calculate a set of partial SSI scores (e.g., partial SSI score 1 210, partial SSI score n 212) from different subsets of metrics 216-222. For example, scoring apparatus 204 may use a linear combination of metrics 216-222 associated with each of four social selling categories (e.g., creating a professional brand, finding prospects, engaging with insights, building relationships), which includes a weight assigned to each metric, to produce a partial SSI score of up to 25 for the corresponding social selling category. Next, scoring apparatus 204 may aggregate the partial SSI scores into SSI score 214. Continuing with the previous example, scoring apparatus 204 may sum the partial SSI scores from the four social selling categories to obtain an overall SSI score 214 of up to 100. Conversely, scoring apparatus 204 may calculate the partial SSI scores and the overall SSI score 214 in a way that unevenly distributes the contribution of individual partial SSI scores on SSI score 214.

Once SSI score 214 is calculated, management apparatus 206 may provide SSI score 214 for use in managing the social selling practices of the sales entity. Management apparatus 206 may include a sales enablement module 232 that displays SSI score 214 and/or previous SSI scores for the sales entity. For example, sales enablement module 232 may be shown within a user interface of the online professional network used by the sales entity to conduct social selling. Within sales enablement module 232, SSI score 214 may be shown numerically and/or in a graph over time. As a result, sales enablement module 232 may be used by the sales entity and/or related entities (e.g., coworkers, managers, recruiters, etc.) to assess the effectiveness of the sales entity's social selling practices and/or changes to the sales entity's social selling practices.

Management apparatus 206 may also provide a ranking module 234 that includes SSI score 214 in a ranking of SSI scores for a set of sales entities. For example, management apparatus 206 may generate a stack-ranked list of sales entities by SSI score and provide the list in ranking module 234. The ranking and/or SSI score 214 may further be used with a planning module 236 in management apparatus 206 to enhance a role of the sales entity. For example, planning module 236 may allow a manager to assign different roles, territories, and/or accounts to different sales entities based on the SSI scores of the sales entities and/or the positions of the sales entities in the ranking. Planning module 236 may also be used by the manager and/or sales entities to develop the sales entities' social selling practices by, for example, providing feedback, analysis, and/or suggestions related to the sales entities' social selling practices. Consequently, the system of FIG. 2 may facilitate sales planning for both individual sales professionals and sales organizations.

Those skilled in the art will appreciate that the system of FIG. 2 may be implemented in a variety of ways. First, analysis apparatus 202, scoring apparatus 204, management apparatus 206, and/or data repository 134 may be provided by a single physical machine, multiple computer systems, one or more virtual machines, a grid, one or more databases, one or more filesystems, and/or a cloud computing system. Analysis apparatus 202, scoring apparatus 204, and management apparatus 206 may additionally be implemented together and/or separately by one or more hardware and/or software components and/or layers.

Second, professional brand data 224, finding prospects data 226, engaging with insights data 228, and/or building relationships data 230 may be obtained from a number of data sources. For example, data repository 134 may include data from a cloud-based data source such as a Hadoop Distributed File System (HDFS) that provides regular (e.g., hourly) updates to data associated with connections, people searches, and/or profile views. Data repository 134 may also include data from an offline data source such as a Structured Query Language (SQL) database, which refreshes at a lower rate (e.g., daily) and provides data associated with profile content (e.g., profile pictures, summaries, education and work history) and/or profile completeness.

Finally metrics 216-222, partial SSI scores, and SSI score 214 may be generated using various techniques. As described above, different gradient scales, formulas, and/or thresholds may be used to calculate metrics 216-222 from data in data repository 134. Such gradient scales, formulas, and/or thresholds may be adjusted to change the effect of the data on the values of metrics 216-222 and, in turn, the effect of metrics 216-222 on the partial SSI scores and SSI score 214. Along the same lines, metrics 216-222 and/or the partial SSI scores may be aggregated into SSI score 214 in different ways. For example, the thresholds and/or weights used to calculate the partial SSI scores from metrics 216-222 and/or combine the partial SSI scores into SSI score 214 may be adjusted to increase and/or decrease the importance and/or effect of different metrics 216-222 and/or partial SSI scores on SSI score 214. In other words, the calculation of SSI score 214 may change as research, analytics, and/or other work related to identifying important social selling factors is performed.

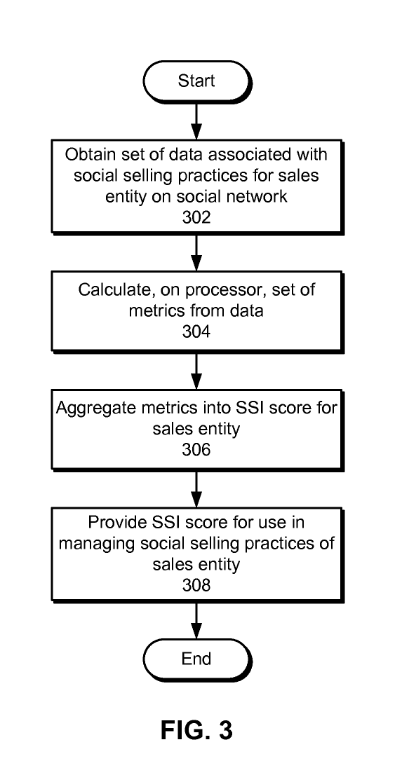

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of data associated with social selling practices for a sales entity on a social network is obtained (operation 302). The data may include the activity, profile, and/or preferences of the sales entity on the social network. For example, the data may include clicks, profile views, searches, profile edits, connections, follows, posts, comments, likes, and/or shares of the sales entity on an online professional network.

Next, a set of metrics is calculated from the data on a processor (operation 304). The metrics may be associated with creating a professional brand, finding prospects, engaging with insights, and building relationships. For example, metrics associated with creating a professional brand may include a profile metric and an endorsement metric. Metrics associated with finding prospects may include a people search metric and a profile view metric. Metrics associated with engaging with insights may include a share metric, an engagement metric, a messaging metric, a group participation metric, and a following metric. Metrics associated with building relationships may include a number of connections, a number of senior connections, and a number of internal connections.

In addition, the metrics may be calculated using different gradient scales. For example, each metric may be calculated from the corresponding subset of data using a different formula and/or set of thresholds. The thresholds and/or formula may also be adjusted to reflect updates to research and/or analytics that further identify and/or categorize the social selling behavior of various sales professionals, such as highly successful sales professionals and/or less successful sales professionals.

The metrics are then aggregated into an SSI score for the sales entity (operation 306). The SSI score may be obtained by calculating a set of partial SSI scores from different subsets of the metrics, and then aggregating the partial SSI scores into the SSI score. For example, four partial SSI scores of up to 25 points each may be calculated from metrics related to four social selling categories (e.g., creating a professional brand, finding prospects, engaging with insights, building relationships). The partial SSI scores may then be summed to obtain an SSI score of up to 100 for the sales entity.

Finally, the SSI score is provided for use in managing the social selling practices of the sales entity (operation 308). For example, the SSI score may be displayed to the sales entity to enable the sales entity to assess his/her sales performance and/or identify factors that positively or negatively affect his/her sales performance. The SSI score may also be included in a ranking of SSI scores for a set of sales entities. In turn, the SSI score and/or ranking may be used to classify a social selling performance of the sales entity (e.g., top or bottom quantile) and/or enhance a role of the sales entity (e.g., assigning accounts and/or tasks to the sales entity, providing suggestions or feedback to the sales entity, etc.).

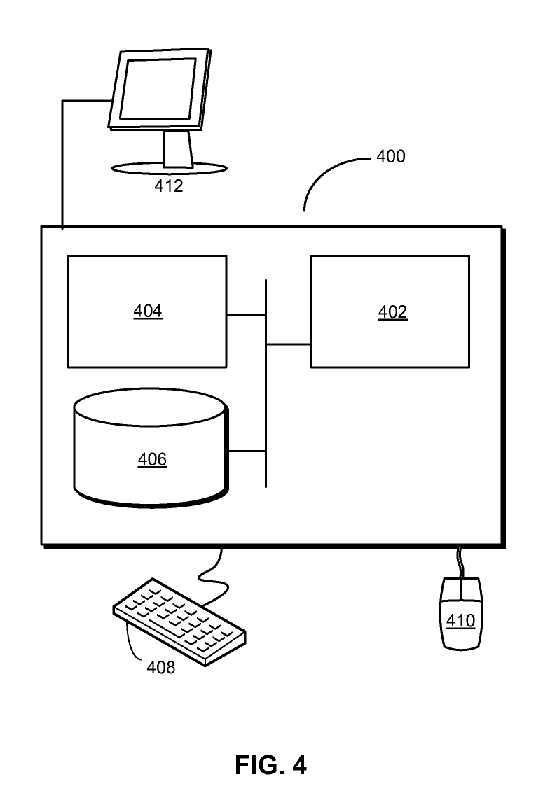

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system may include an analysis apparatus that obtains a set of data associated with social selling practices for a sales entity on a social network and calculates a set of metrics from the data, including metrics associated with creating a professional brand, finding prospects, engaging with insights, and building relationships. The system may also include a scoring apparatus that aggregates the metrics into a social selling index (SSI) score for the sales entity. Finally, the system may include a management apparatus that provides the SSI score for use in managing the social selling practices of the sales entity.

In addition, one or more components of computer system 400 may be remotely located and connected to the other components over a network. Portions of the present embodiments (e.g., analysis apparatus, scoring apparatus, management apparatus, identification mechanism, etc.) may also be located on different nodes of a distributed system that implements the embodiments. For example, the present embodiments may be implemented using a cloud computing system that calculates and provides a set of SSI scores for a set of remote sales entities to facilitate management of the sales entities' social selling practices on a social and/or online professional network.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for processing data, comprising:
obtaining a set of data associated with social selling practices for a sales entity on a social network;
calculating, on a processor, a set of metrics from the data, wherein the metrics are associated with creating a professional brand, finding prospects, engaging with insights, and building relationships;
aggregating the metrics into a social selling index (SSI) score for the sales entity; and
providing the SSI score for use in managing the social selling practices of the sales entity.

2. The computer-implemented method of claim 1, wherein a subset of the metrics associated with creating the professional brand comprises:
a profile metric; and
an endorsement metric.

3. The computer-implemented method of claim 2, wherein the profile metric is at least one of:
a profile completeness;
a profile length; and
a rich content metric.

4. The computer-implemented method of claim 1, wherein a subset of the metrics associated with finding prospects comprises:
a people search metric; and
a profile view metric.

5. The computer-implemented method of claim 4, wherein the people search metric is associated with an advanced people search.

6. The computer-implemented method of claim 4, wherein the profile view metric is associated with at least one of:
profile views;
prospecting profile views; and
inbound profile views.

7. The computer-implemented method of claim 1, wherein a subset of the metrics associated with engaging with insights comprises:
a share metric;
an engagement metric;
a messaging metric;
a group participation metric; and
a following metric.

8. The computer-implemented method of claim 7, wherein the engagement metric is associated with at least one of a like, a comment, and a re-share.

9. The computer-implemented method of claim 1, wherein a subset of the metrics associated with building relationships comprises:
a number of connections;
a number of senior connections; and
a number of internal connections.

10. The computer-implemented method of claim 1, wherein the set of metrics is calculated by applying a set of gradients to different subsets of the data.

11. The computer-implemented method of claim 1, wherein aggregating the metrics into the SSI score for the entity comprises:
calculating a set of partial SSI scores from different subsets of the metrics; and
aggregating the partial SSI scores into the SSI score.

12. The computer-implemented method of claim 1, wherein providing the SSI score for use in managing the social selling practices of the sales entity comprises at least one of:
displaying the SSI score to the sales entity;
including the SSI score in a ranking of SSI scores for a set of sales entities;
using the SSI score or the ranking to classify a social selling performance of the sales entity; and
using the SSI score or the ranking to enhance a role of the sales entity.

13. An apparatus, comprising:
one or more processors; and
memory storing instructions that, when executed by the one or more processors, cause the apparatus to:
obtain a set of data associated with social selling practices for a sales entity on a social network;
calculate a set of metrics from the data, wherein the metrics are associated with creating a professional brand, finding prospects, engaging with insights, and building relationships;
aggregate the metrics into a social selling index (SSI) score for the sales entity; and
provide the SSI score for use in managing the social selling practices of the sales entity.

14. The apparatus of claim 13, wherein a subset of the metrics associated with creating the professional brand comprises:
a profile metric; and
an endorsement metric.

15. The apparatus of claim 13, wherein a subset of the metrics associated with finding prospects comprises:
a people search metric; and
a profile view metric.

16. The apparatus of claim 13, wherein a subset of the metrics associated with engaging with insights comprises:
a share metric;
an engagement metric;
a messaging metric;
a group participation metric; and
a following metric.

17. The apparatus of claim 13, wherein a subset of the metrics associated with building relationships comprises:
a number of connections;
a number of senior connections; and
a number of internal connections.

18. The apparatus of claim 13, wherein providing the SSI score for use in managing the social selling practices of the sales entity comprises at least one of:
displaying the SSI score to the sales entity;
including the SSI score in a ranking of SSI scores for a set of sales entities;
using the SSI score to classify a social selling performance of the sales entity; and
using the SSI score to enhance a role of the sales entity.

19. A system for processing data, comprising:
an analysis apparatus configured to:
obtain a set of data associated with social selling practices for a sales entity on a social network; and
calculate a set of metrics from the data, wherein the metrics are associated with creating a professional brand, finding prospects, engaging with insights, and building relationships;
a scoring apparatus configured to aggregate the metrics into a social selling index (SSI) score for the sales entity; and
a management apparatus configured to provide the SSI score for use in managing the social selling practices of the sales entity.

20. The system of claim 19, wherein providing the SSI score for use in managing the social selling practices of the sales entity comprises at least one of:
displaying the SSI score to the entity;
including the SSI score in a ranking of SSI scores for a set of sales entities;
using the SSI score to classify a social selling performance of the sales entity; and
using the SSI score to enhance a role of the sales entity.
